(19) United States
(12) Patent Application Publication
(10) Pub. No.: US 2019/0291549 A1
(43) Pub. Date: Sep. 26, 2019

(54) SUNROOF APPARATUS AND METHOD OF MANUFACTURING THE SAME

(71) Applicant: AISIN SEIKI KABUSHIKI KAISHA, Kariya-shi (JP)

(72) Inventors: Tatsuya MATSUI, Kariya-shi (JP); Shinichi HIRAMATSU, Chiryu-shi (JP); Satoshi KONO, Anjo-shi (JP)

(73) Assignee: AISIN SEIKI KABUSHIKI KAISHA, Kariya-shi (JP)

(21) Appl. No.: 16/361,436

(22) Filed: Mar. 22, 2019

(30) Foreign Application Priority Data
Mar. 26, 2018 (JP) 2018-058640

(51) Int. Cl. B60J 7/053; B60J 7/05

(52) U.S. Cl. CPC B60J 7/053; B60J 7/05

(57) ABSTRACT

A sunroof apparatus includes a movable panel including a panel body, a reinforcing member, and a joining layer joining the panel body and the reinforcing member, and an opening and closing mechanism including a connection member connected to the reinforcing member and a drive portion, the reinforcing member including a first flange, a second flange to define a housing groove relative to the first flange, a first extending portion, and a second extending portion, the connection member being connected to at least one of the first extending portion and the second extending portion in a state of being housed in a housing void formed between the first extending portion and the second extending portion, the movable panel including a shielding member covering the housing groove and including a thickness smaller than a thickness of the first flange and the second flange.

### CROSS REFERENCE TO RELATED APPLICATIONS

This application is based on and claims priority under 35 U.S.C. § 119 to Japanese Patent Application 2018-058640, filed on Mar. 26, 2018, the entire content of which is incorporated herein by reference.

### TECHNICAL FIELD

This disclosure generally relates to a sunroof apparatus and a method of manufacturing the same.

### BACKGROUND DISCUSSION

A known sliding roof system such as disclosed in US20120217770A1, for example, includes a cover (panel body) opening and closing a roof opening portion of a vehicle, a reinforcing element (reinforcing member) adhered to the cover via a PU form (resin layer), a guide rail (connecting member) connected to the reinforcing element, and a sliding piece movably engaging with the guide rail. In the aforementioned sliding roof system, the sliding piece is moved in a front-rear direction of the vehicle to open and close the cover.

According to the aforementioned sliding roof system, the guide rail is arranged away from the cover by a thickness of the reinforcing member because the reinforcing member is disposed between the cover and the guide rail in a height direction of the vehicle. Thus, reducing a thickness of the sliding roof system in the height direction of the vehicle is desirable.

A need thus exists for a sunroof apparatus and a method of manufacturing the same which are not susceptible to the drawback mentioned above.

### SUMMARY

According to an aspect of this disclosure, a sunroof apparatus includes a movable panel including a panel body configured to open and close a roof opening portion provided at a vehicle, a reinforcing member provided at each of opposed end portions of the panel body in a width direction of the vehicle and extending in a front-rear direction of the vehicle, and a joining layer joining the panel body and the reinforcing member, and an opening and closing mechanism including a connection member connected to the reinforcing member and a drive portion configured to open and close the movable panel by driving the connection member. The reinforcing member includes a first flange, a second flange provided at an inside of the first flange in the width direction to define a housing groove relative to the first flange, the housing groove extending in the front-rear direction, a first extending portion protruding to a vehicle interior from an inner end of the first flange in the width direction, and a second extending portion protruding to the vehicle interior from an outer end of the second flange in the width direction. The connection member is connected to at least one of the first extending portion and the second extending portion in a state of being housed in a housing void formed between the first extending portion and the second extending portion. The movable panel includes a shielding member covering the housing groove and including a thickness smaller than a thickness of the first flange and the second flange.

According to another aspect of this disclosure, a method of manufacturing a sunroof apparatus, the sunroof apparatus including a movable panel including a panel body configured to open and close a roof opening portion provided at a vehicle, a reinforcing member provided at each of opposed end portions of the panel body in a width direction of the vehicle and extending in a front-rear direction of the vehicle, and a joining layer joining the panel body and the reinforcing member, and an opening and closing mechanism including a connection member connected to the reinforcing member and a drive portion configured to open and close the movable panel by driving the connection member, the reinforcing member including a first flange, a second flange provided at an inside of the first flange in the width direction to define a housing groove relative to the first flange, the housing groove extending in the front-rear direction, a first extending portion protruding to a vehicle interior from an inner end of the first flange in the width direction, and a second extending portion protruding to the vehicle interior from an outer end of the second flange in the width direction, the connection member being connected to at least one of the first extending portion and the second extending portion in a state of being housed in a housing void formed between the first extending portion and the second extending portion, the movable panel including a shielding member covering the housing groove and including a thickness smaller than a thickness of the first flange and the second flange, the method including a first process covering the housing groove by the shielding member, a second process arranging the panel body and the reinforcing member at a molding die, a third process injecting a liquid material for forming the joining layer to the molding die where the panel body and the reinforcing member are arranged, and a fourth process for forming the joining layer by hardening the liquid material.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view schematically illustrating a vehicle according to an embodiment disclosed here;

FIG. 2 is a side view of a movable panel and an opening and closing mechanism according to the embodiment;

FIG. 3 is a plan view of the movable panel;

FIG. 4 is an exploded perspective view of the movable panel;

FIG. 5A is a perspective view of a side frame of the movable panel;

FIG. 5B is a perspective view of the side frame of the movable panel;

FIG. 6A is a partial perspective view of a resin frame of the movable panel;

FIG. 6B is a partial perspective view of the resin frame of the movable panel;

FIG. 7A is a cross-sectional view taken along line 7A-7A in FIG. 3;

FIG. 7B is an enlarged view of FIG. 7A;

FIG. 7C is a cross-sectional view taken along line 7C-7C in FIG. 3;

FIG. 7D is a cross-sectional view taken along line 7D-7D in FIG. 3; and

FIGS. 8A to 8C are schematic views for explaining a manufacturing method of the movable panel.

### DETAILED DESCRIPTION

An embodiment is explained with reference to the attached drawings.

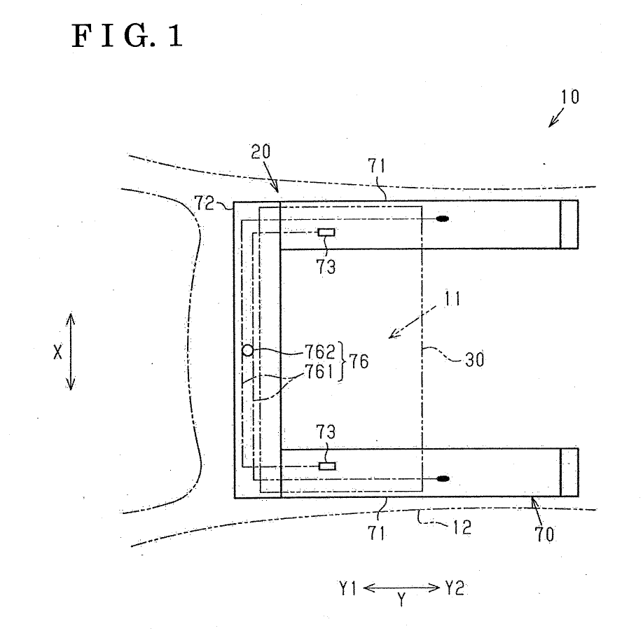

As illustrated in FIG. 1, a vehicle 10 includes a roof 12 at which a roof opening portion 11 is provided and a sunroof apparatus 20 configured to open and close the roof opening portion 11.

The sunroof apparatus 20 includes a movable panel 30 movable between an open position for opening the roof opening portion 11 and a closed position for closing the roof opening portion 11, and an opening and closing mechanism 70 causing the movable panel 30 to open and close. In the following explanation, a width direction of the vehicle 10 may be simply referred to as a width direction X and a front-rear direction of the vehicle 10 may be simply referred to as a front-rear direction Y.

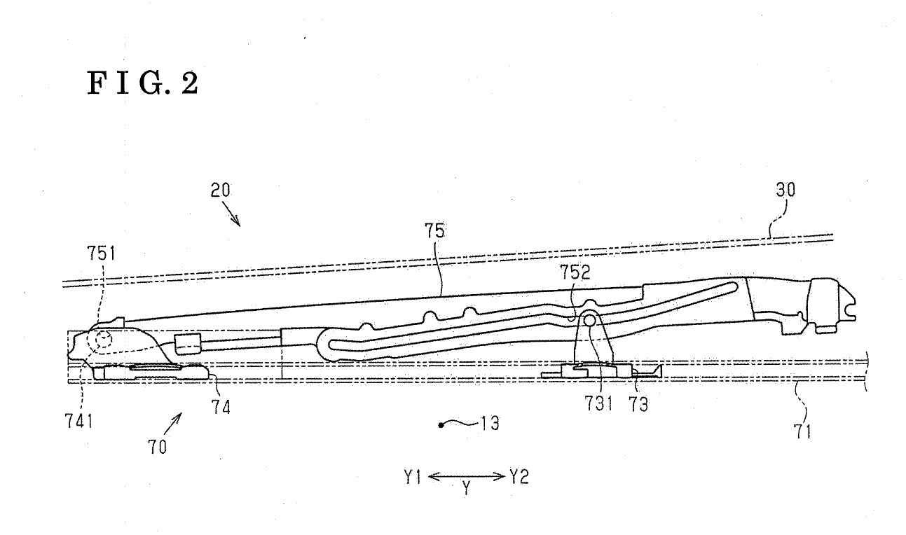

As illustrated in FIG. 1, the opening and closing mechanism 70 includes guide rails 71 provided at opposed end portions of the roof opening portion 11 in the width direction X, and a front housing 72 provided at a front end portion of the roof opening portion 11. In addition, as illustrated in FIGS. 1 and 2, the opening and closing mechanism 70 includes a drive shoe 73 and a driven shoe 74 which move along each of the guide rails 71, a functional bracket 75 supported at the drive shoe 73 and the driven shoe 74 moving along the guide rail 71, and an actuator 76 driving the functional bracket 75 via the drive shoe 73. In the opening and closing mechanism 70, the drive shoe 73, the driven shoe 74, and the functional bracket 75 are provided at each of the opposed end portions of the roof opening portion 11, i.e., the opening and closing mechanism 70 includes a pair of guide rails 71, a pair of drive shoes 73, a pair of driven shoes 74, and a pair of functional brackets 75.

As illustrated in FIGS. 1 and 2, each of the guide rails 71 is formed in an elongated form extending in the front-rear direction Y. The guide rail 71 includes a void where the drive shoe 73, the driven shoe 74, and the functional bracket 75, for example, move in a longitudinal direction of the guide rail 71. As illustrated in FIG. 1, the front housing 72 connects between front end portions of the pair of guide rails 71 in the width direction X.

As illustrated in FIG. 2, the drive shoe 73 is provided at a rear Y2 relative to the driven shoe 74. The drive shoe 73 includes a first support shaft 731 for supporting the functional bracket 75 while the driven shoe 74 includes a second support shaft 741 for supporting the functional bracket 75.

As illustrated in FIG. 2, the functional bracket 75 is formed in an elongated form to support each end portion of the movable panel 30 in the width direction X. That is, the pair of functional brackets 75 supports opposed end portions of the movable panel 30 in the width direction X. The functional bracket 75 includes a support bore 751 at a front end portion so that the second support shaft 741 of the driven shoe 74 is inserted to be positioned within the support bore 751. The functional bracket 75 also includes a guide bore 752 at a rear portion relative to the front end portion of the functional bracket 75 so that the first support shaft 731 of the drive shoe 73 is inserted to be positioned within the guide bore 752. The guide bore 752 extends along a longitudinal direction of the functional bracket 75 so as to incline vertically upward towards a rear end of the functional bracket 75. The front end portion of the functional bracket 75 is rotatably supported at the driven shoe 74 (the second support shaft 741) and the rear portion relative to the front end portion is supported at the drive shoe 73 (the first support shaft 731).

As illustrated in FIG. 1, the actuator 76 is provided at the guide rails 71 and the front housing 72. Specifically, the actuator 76 includes a drive belt 761 extending along the guide rails 71 and the front housing 72, and a motor 762 causing the drive belt 761 to extend and retract. The drive belt 761 is connected to the respective drive shoes 73.

An operation of the sunroof apparatus 20 is explained as below. In the sunroof apparatus 20, the actuator 76 is driven so as to bring the drive shoes 73 to move along the respective guide rails 71. For example, the drive shoe 73 is driven to move to a front Y1 from the position illustrated in FIG. 2. The drive shoe 73 then pushes up the functional bracket 75 so that a front end portion of the movable panel 30 is raised relative to a rear end portion thereof. That is, the movable panel 30 is tilted up. The drive shoe 73 is also driven to move to the rear Y2 from the position illustrated in FIG. 2. The drive shoe 73 then pushes down the functional bracket 75 so that the rear end portion of the movable panel 30 is lowered relative to the front end portion thereof. That is, the movable panel 30 is tilted down. Accordingly, the roof opening portion 11 is opened and closed by tilting-up and tilting-down of the movable panel 30.

In the sunroof apparatus 20, in a state where the movable panel 30 is tilted down, each of the drive shoes 73 is further moved to the rear Y2 The movable panel 30 is then hidden under the roof 12 to thereby greatly open the roof opening portion 11. Accordingly, the roof opening portion 11 is opened and closed also by sliding of the movable panel 30 in the front-rear direction Y.

In the sunroof apparatus 20 according to the embodiment, the functional bracket 75 is driven by the drive shoe 73, the driven shoe 74, and the actuator 76 to open and close the movable panel 30. That is, the drive shoe 73, the driven shoe 74, and the actuator 76 constitute an example of a driving portion.

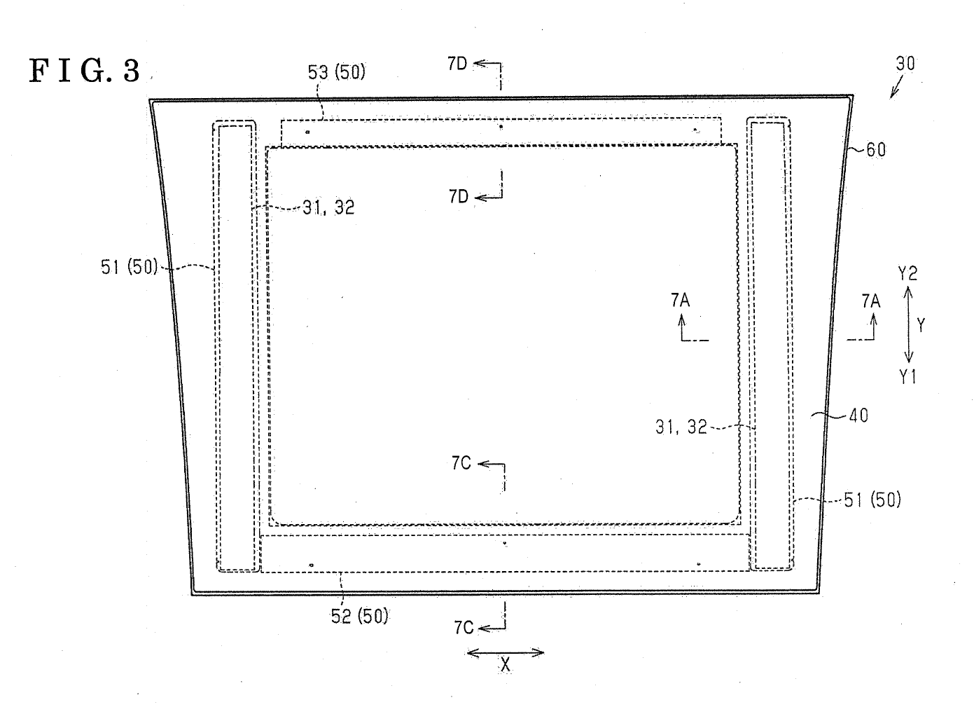

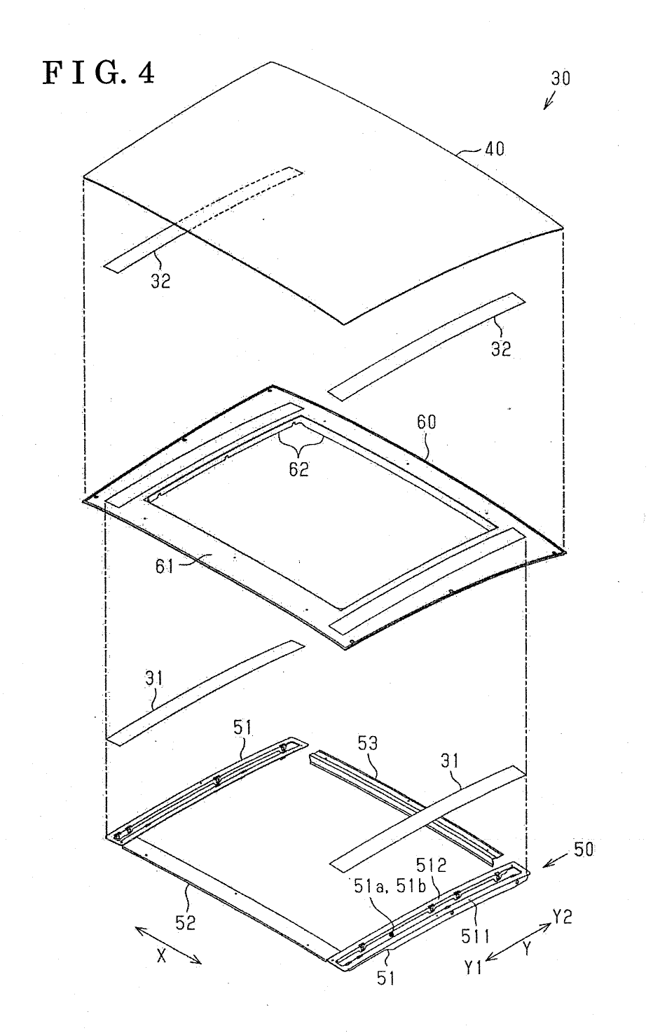

Next, the movable panel 30 is explained in detail. As illustrated in FIGS. 3 and 4, the movable panel 30 includes a panel body 40 opening and closing the roof opening portion 11, a reinforcing frame 50 reinforcing the panel body 40, and a resin frame 60 joining and connecting the panel body 40 and the reinforcing frame 50 each other. The movable panel 30 also includes films 31 disposed between the reinforcing frame 50 and the resin frame 60, and sheets 32 disposed between the panel body 40 and the resin frame 60 (reinforcing frame 50). In the present embodiment, the resin frame 60 serves as an example of a joining layer. The film 31 serves as an example of a shielding member and the sheet 32 serves as an example of an elastic member.

The panel body 40 is made from a transparent material such as glass and resin, for example. In the present embodiment, the panel body 40 is formed in a plate form including a substantially trapezoid configuration in a plan view. The panel body 40 is curved in a way that a center portion is positioned vertically upward relative to opposed end portions in the width direction X and a center portion is positioned vertically upward relative to opposed end portion in the front-rear direction Y.

The reinforcing frame 50 includes a pair of side frames 51 serving as an example of a reinforcing member, a front frame 52, and a rear frame 53. The pair of side frames 51 is provided at the opposed end portions of the panel body 40 in the width direction X to extend in the front-rear direction Y. The front frame 52 is provided at a front end portion of the panel body 40 to extend in the width direction X. The rear frame 53 is provided at a rear end portion of the panel body 40 to extend in the width direction X. The side frames 51, the front frame 52, and the rear frame 53 are made from a material including higher elastic modulus, such as metal, for example, than the panel body 40. The side frames 51, the front frame 52, and the rear frame 53 are curved while extending along the panel body 40.

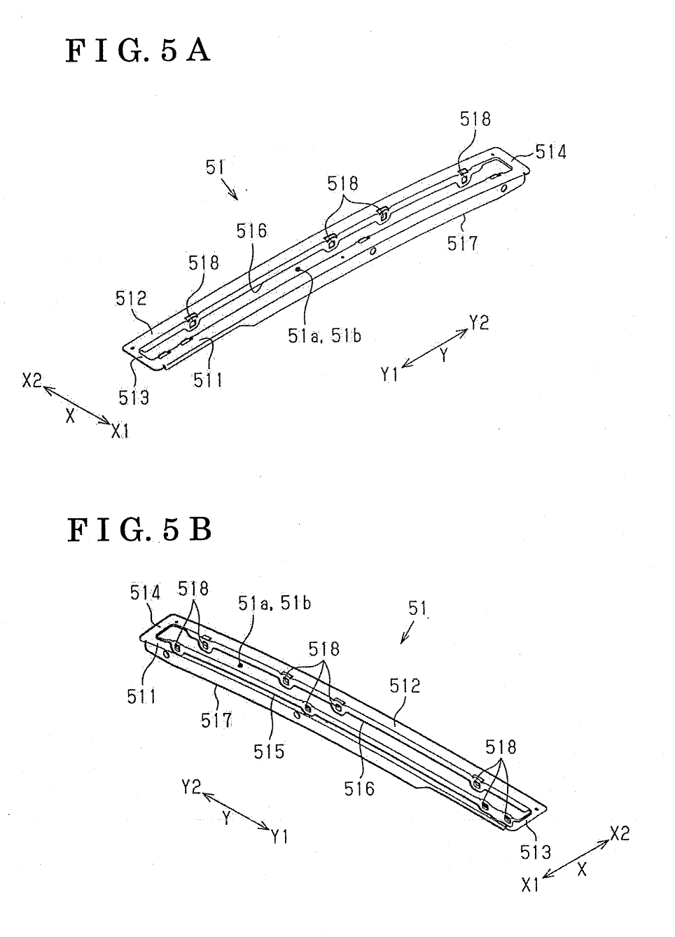

As illustrated in FIGS. 5A and 5B, each of the side frames 51 includes a first flange 511, a second flange 512, a third flange 513, and a fourth flange 514 which face the panel body 40, and a first extending portion 515, a second extending portion 516, and a third extending portion 517 which extend in a direction orthogonal to the panel body 40.

The first flange 511 and the second flange 512, each of which is formed in a thin plate form, extend in the front-rear direction Y. The second flange 512 is arranged at an inside X2 relative to the first flange 511 in the width direction X so define housing groove 51a relative to the first flange 511, the housing groove 51a extending in the front-rear direction Y. The third flange 513 and the fourth flange 514, each of which is formed in a thin plate form, extends in the width direction X. The third flange 513 connects between front ends of the first flange 511 and the second flange 512. The fourth flange 514 connects between the rear ends of the first flange 511 and the second flange 512. That is, the third flange 513 defines a front end of the housing groove 51a and the fourth flange 514 defines a rear end of the housing groove 51a. The first flange 511, the second flange 512, the third flange 513, and the fourth flange 514 include respective surfaces facing the panel body 40 and substantially coplanar with one another.

As illustrated in FIGS. 5A and 5B, the first extending portion 515, the second extending portion 516, and the third extending portion 517 each of which is formed in a thin plate form extend in the front-rear direction Y. The first extending portion 515 extends while bending relative to the first flange 511 from an inner end of the first flange 511 in the width direction X. The second extending portion 516 extends while bending relative to the second flange 512 from an outer end of the second flange 512 in the width direction X. The third extending portion 517 extends while bending relative to the first flange 511 from an outer end of the first flange 511 in the width direction X. Thus, in a state where the sunroof apparatus 20 is mounted at the vehicle 10, the first extending portion 515, the second extending portion 516, and the third extending portion 517 extend towards a vehicle interior 13 (see FIG. 2) which is positioned vertically downward relative to the roof 12.

The first extending portion 515 and the second extending portion 516 form or define a housing void 51b therebetween for housing the functional bracket 75. The housing void 51b is a void continuously connected to the housing groove 51a. Each of the first extending portion 515 and the second extending portion 516 includes plural fixation bores 518 for fixing the functional bracket 75 to the side frame 51.

The side frame 51 is connected to the functional bracket 75 in a state where the functional bracket 75 is housed at the housing void 51b. Specifically, the first extending portion 515 and the second extending portion 516 of the side frame 51 and the functional bracket 75 are connected to one another by fastening members such as bolts which are inserted to be positioned within the respective fixation bores 518. In the embodiment, the functional bracket 75 serves as an example of a connection member.

As illustrated in FIG. 4, the front frame 52 is arranged between the pair of side frames 51 so as to connect front ends of the pair of side frames 51 each other. The rear frame 53 is arranged between the pair of side frames 51 so as to connect rear ends of the pair of side frames 51 each other. Each of the front frame 52 and the rear frame 53 desirably includes a cross-section so that bending rigidity of each of the front frame 52 and the rear frame 53 is enhanced.

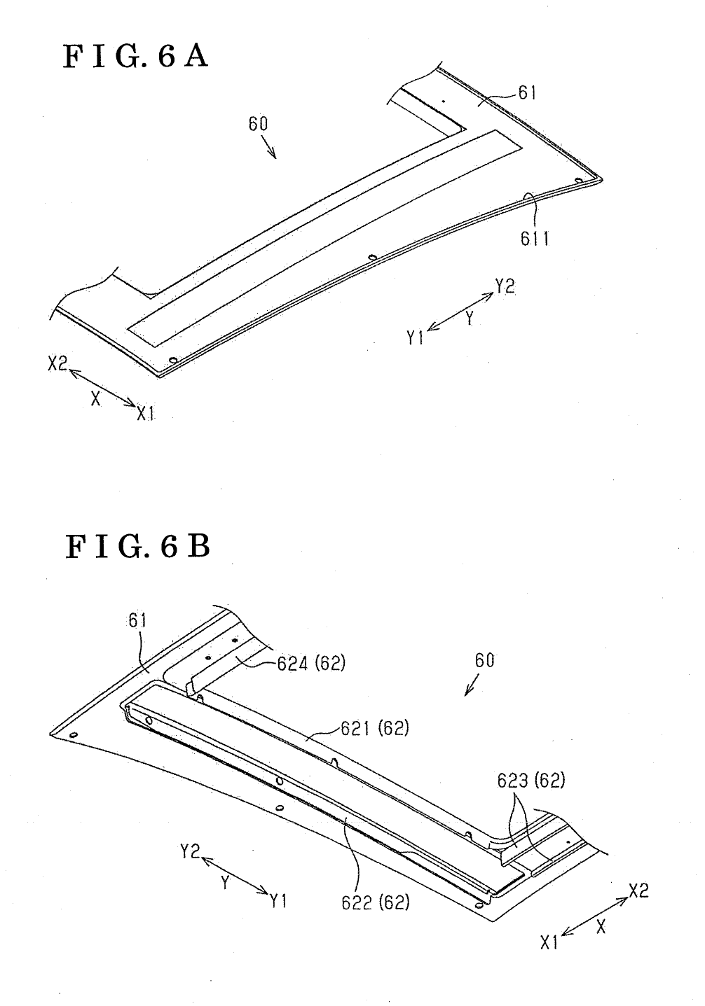

As illustrated in FIGS. 6A and 6B, the resin frame 60 is formed of urethane resin and epoxy resin, for example. The resin frame 60 include body portion 61 in a rectangular frame form, and plural cover portions 62 protruding from a rear surface of the body portion 61. The body portion 61 includes a configuration (dimensions) greater than the panel body 40. A protective portion 611 is formed at an outer edge of the body portion 61 so as to protrude from a front surface thereof. The protective portion 611 protects an outer edge (an outer circumferential edge) of the panel body 40 and increases appearance of the panel body 40 by surrounding a circumference of the panel body 40. As illustrated in FIG. 6B, the cover portion 62 includes a first cover portion 621 provided at each of opposed end portions of the body portion 61 in the width direction X so as to extend in the front-rear direction Y, and a second cover portion 622 provided at an outside X1 relative to the first cover portion 621 so as to extend in the front-rear direction Y. The cover portion 62 also includes a third cover portion 623 provided at a front end portion so as to extend in the width direction X and a fourth cover portion 624 provided at a rear end portion so as to extend in the width direction X.

As illustrated in FIGS. 3 and 4, the film 31 is in a substantially rectangular form in a plan view. The film 31 includes a configuration (dimensions) greater than the housing groove 51a of the side frame 51 in the plan view and includes a thickness smaller than the first flange 511 and the second flange 512 of the side frame 51. The film 31 may be formed of elastomer such as rubber and resin, for example. The film 31 is attached to front surfaces of the first to fourth flanges 511, 512, 513, 514 of the side frame 51 so as to cover the housing groove 51a of the side frame 51.

As illustrated in FIGS. 3 and 4, the sheet 32 includes a similar configuration to the film 31 in the plan view and includes a thickness greater than the film 31. The sheet 32 is made from a compressible material with less elastic modulus than the panel body 40 and the resin frame 60. For example, the sheet 32 may be formed of form such as sponge, for example. The sheet 32 is attached to a part of the panel body 40 facing the side frame 51. Specifically, the sheet 32 may be desirably attached to a rear surface of the panel body 40 to face at least a part of the first flange 511 and the second flange 512 of the side frame 51 in the plan view.

As illustrated in FIG. 3, the movable panel 30 is integrally formed by the panel body 40 where the sheets 32 are attached, the reinforcing frame 50 where the films 31 are attached, and the resin frame 60 by insert-molding.

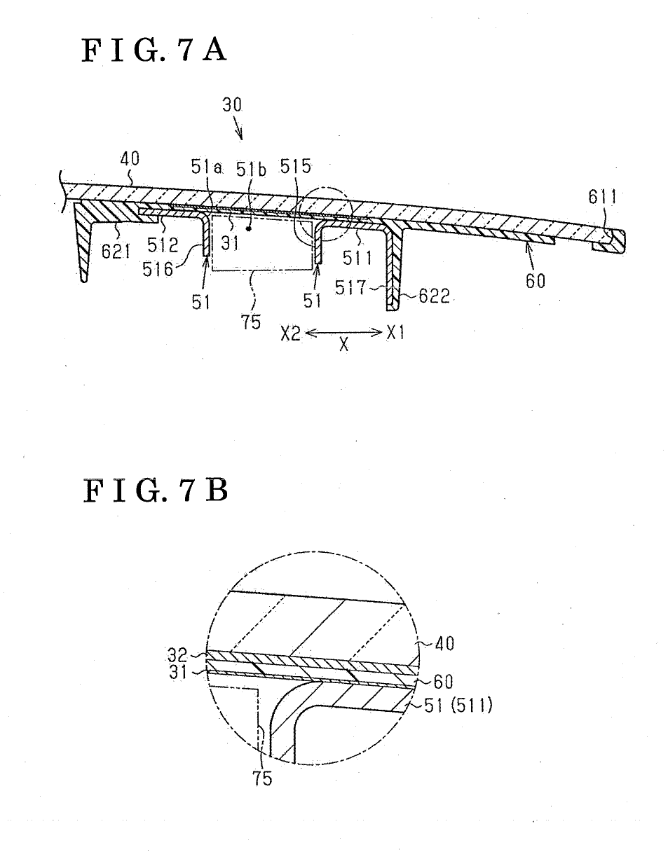

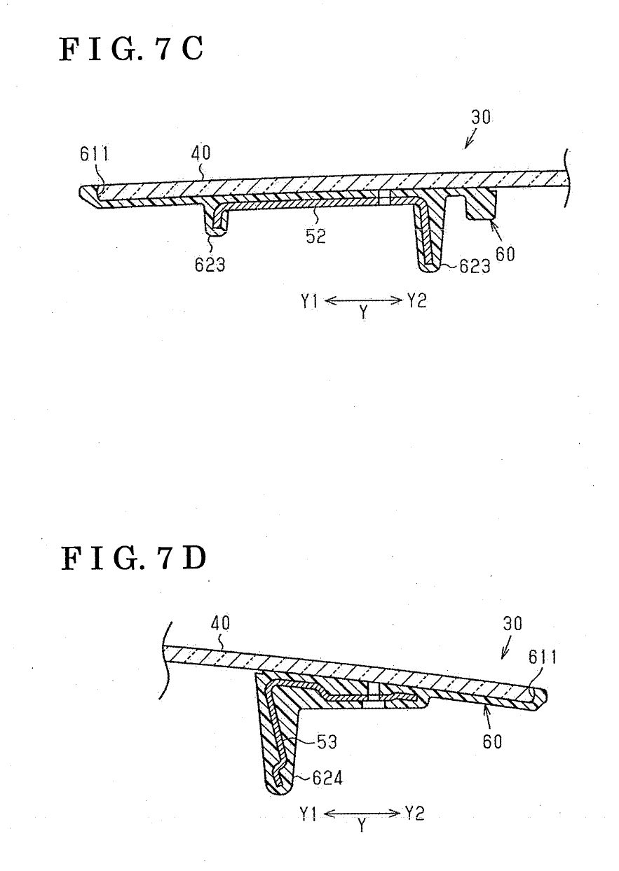

Specifically, as illustrated in FIGS. 7A and 7B, an inner end of the second flange 512 in the width direction X is covered by the first cover portion 621 of the resin frame 60. The third extending portion 517 is covered by the second cover portion 622 of the resin frame 60. As illustrated in FIG. 7C, the front frame 52 is covered by the third cover portion 623 of the resin frame 60. As illustrated in FIG. 7D, the rear frame 53 is covered by the fourth cover portion 624 of the resin frame 60. As illustrated in FIGS. 7A to 7D, the outer circumferential edge of the panel body 40 is covered by the protective portion 611 of the resin frame 60.

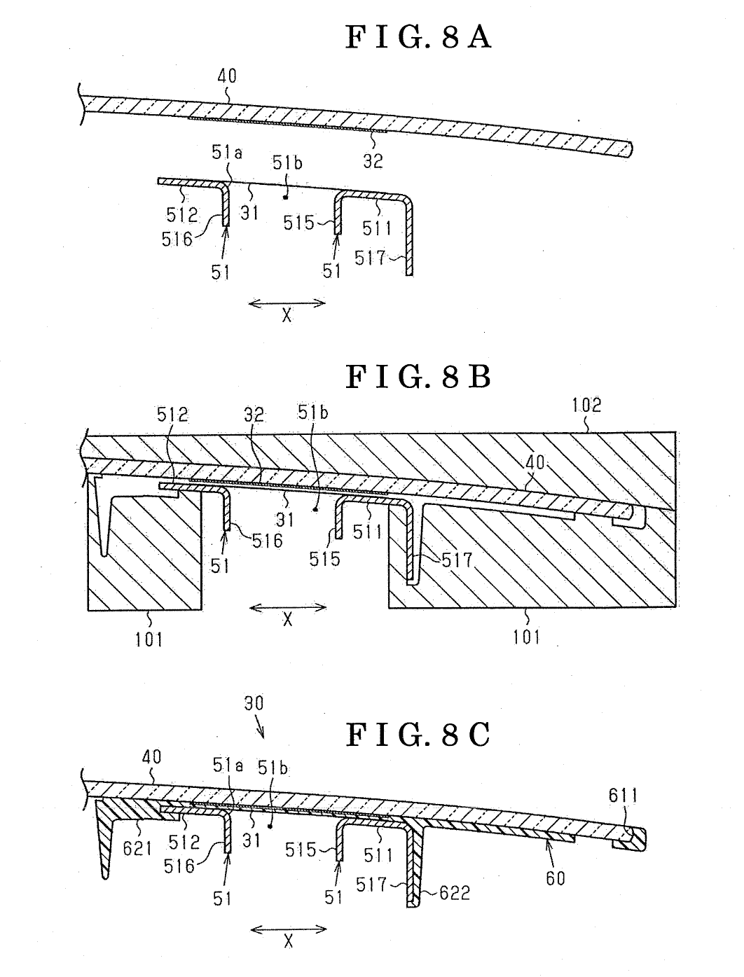

Next, a manufacturing method of the sunroof apparatus 20 (the movable panel 30) is explained with reference to FIGS. 8A, 8B, and 8C. As illustrated in FIG. 8A, in a case of manufacturing the movable panel 30, the film 31 is attached to the side frame 51 so as to cover the housing groove 51a of the side frame 51, and the sheet 32 is attached to the rear surface of the panel body 40 (a first process). Then, as illustrated in FIG. 8B, the side frame 51, the front frame 52, and the rear frame 53 are set to a first molding die 101 and the panel body 40 is set so that a clearance is formed relative to the side frame 51 (a second process). The panel body 40 is covered by a second molding die 102 and thereafter a liquid material for forming the resin frame 60 is injected between the first molding die 101 and the second molding die 102 as illustrated in FIG. 8C (a third process). In the embodiment, because the housing groove 51a is covered by the film 31, the liquid material is restrained from flowing to the housing void 51b even when the liquid material flows between the panel body 40 and the side frame 51, specifically, between the film 31 and the sheet 32. Finally, the liquid material injected between the first molding die 101 and the second molding die 102 is hardened to form the resin frame 60 (a fourth process). As a result, the movable panel 30 is insert-molded according to the embodiment.

As for the insert-molding, a reaction injection molding (RIM) may be desirably employed. According to the RIM, a pressure of injecting liquid material may be reduced as compared to a normal injection molding for injecting molten resin. The liquid material for the RIM is a mixture of two components, i.e., a main component for polymerization of urethane resin and epoxy resin, and hardener. In addition, for the purposes of hardening the liquid material (the fourth process), heating the first molding die 101 and the second molding die 102 is necessary.

According to the sunroof apparatus 20 of the embodiment, although the resin frame 60 and the films 31 are disposed between the panel body 40 and the functional brackets 75, members corresponding to the first flange 511 and the second flange 512 are inhibited from being disposed between the panel body 40 and the functional bracket 75. At this time, the thickness of the film 31 is smaller than the thickness of the first flange 511 and the second flange 512. Thus, according to the sunroof apparatus 20 of the embodiment, the functional bracket 75 is provided and positioned closer to the panel body 40. Specifically, as illustrated in FIGS. 7A and 7B, an upper end of the functional bracket 75 is arranged above a lower surface of the first flange 511 and a lower surface of the second flange 512. Accordingly, a reduction of thickness of the sunroof apparatus 20 in a height direction of the vehicle 10 is achievable. In addition, because the housing groove 51a is covered by the film 31, the resin frame 60 is restrained from being arranged towards the housing void 51b via the housing groove 51a.

In the sunroof apparatus 20, the housing groove 51a is covered by the film 31 which is attached to the first flange 511 and the second flange 512. Thus, the film 31 which covers the clearance (i.e., the housing groove 51a) between the first flange 511 and the second flange 512 may be easily constructed.

The film 31 is attached to the third flange 513 and the fourth flange 514 in addition to the first flange 511 and the second flange 512. Thus, a space (portion) to which the film 31 is attached may be easily secured. As a result, the housing groove 51a may be securely covered by the film 31.

In the present embodiment, the movable panel 30 is heated upon hardening of the resin frame 60. The movable panel 30 is then cooled. Thus, if a difference in coefficient of thermal expansion between the side frame 51 and the panel body 40 is large, strain may remain at the panel body 40 because of thermal deformation (compression) of the side frame 51 at the time of cooling the movable panel 30. In view of the above, because the movable panel 30 includes the sheet 32 with low elastic modulus, the sheet 32 is deformed actively as compared to the panel body 40 at the time the movable panel 30 is cooled. As a result, in the sunroof apparatus 20, strain is restrained from remaining at the panel body 40.

In the manufacturing method of the movable panel 30 according to the embodiment, the housing groove 51a is covered by the film 31 in the first process. Thus, in the third process, the liquid material forming the resin frame 60 is restrained from flowing to the housing void 51b. That is, in the manufacturing method according to the embodiment, the housing void 51b for arranging the functional bracket 75 may be easily provided.

In the manufacturing method of the movable panel 30 according to the embodiment, because the movable panel 30 is formed by the RIM, it is not necessary to inject the molten resin at high pressure between the first molding die 101 and the second molding die 102. Simply covering the housing groove 51a of the side frame 51 by the film 31 restrains the molten resin from flowing to the housing void 51b at the time of injection molding of the movable panel 30.

The embodiment may be appropriately changed or modified as follows. Examples of changes or modifications as below may be appropriately combined with each other. The movable panel 30 may not include the sheets 32. In addition, the movable panel 30 may not include the front frame 52 or the rear frame 53.

The side frame 51 may be constituted by two members. Specifically, the side frame 51 may be constituted by a portion including the first flange 511 and the first extending portion 515 and a portion including the second flange 512 and the second extending portion 516.

Each of the front frame 52 and the rear frame 53 may be formed in a hollow bar form. In this case, when manufacturing the movable panel 30, a construction or a structure corresponding to the film 31 may be desirably attached to each of the opposed end portions of the front frame 52 and the rear frame 53 in a longitudinal direction thereof so as to cover the opening of each of the opposed end portions. Accordingly, the liquid resin is restrained from flowing from the opening at each of the end portions of the front frame 52 and the rear frame 53 in the longitudinal direction thereof at the time of insert-molding (RIM) of the movable panel 30.

The resin frame 60 may be a resin layer having dimensions for joining and connecting at least the panel body 40 and the side frames 51. The liquid material injected between the first molding die 101 and the second molding die 102 in the insert molding may be thermoplastic resin or thermosetting resin. In this case, material and strength of the films 31 may be desirably selected so as to endure a pressure of liquid material (molten resin) at the time of injection molding.

The film 31 may cover the housing groove 51a in a state of being attached to the first extending portion 515 and the second extending portion 516. As long as the housing groove 51a is covered, the film 31 is not necessary to form a thin film form.

Each of the sheets 32 may include dimensions to overlap the side frame 51 in a plan view of the movable panel 30. As a result, because of the sheets 32 with low elastic modulus, the sheets 32 are deformed actively as compared to the panel body 40 at the time the movable panel 30 is cooled. As a result, in the sunroof apparatus 20, strain is further restrained from remaining at the panel body 40.

The sheet 32 is not necessary to be a plate form as long as the sheet 32 can absorb thermal strain at the time the movable panel 30 is manufactured. The film 31 and the sheet 32 may be integrally constituted. Specifically, the film 31 may include a function of the sheet 32.

The thickness of the film 31 and the thickness of the sheet 32 may be specified so that a sum of the thickness of the film 31 and the thickness of the sheet 32 at the end portion of the movable panel 30 in the width direction X is substantially equal to a clearance between the panel body 40 and the side frame 51. That is, the side frame 51 (reinforcing member) is not necessary to be provided between the film 31 and the sheet 32.

A slide core may be employed or not employed in a case where the movable panel 30 is insert-molded. The sunroof apparatus 20 may be configured so that the roof opening portion 11 is opened and closed by the tilting-down and the tilting-up of the movable panel 30 or by sliding of the movable panel 30. In addition, the opening and closing mechanism 70 may be appropriately changed. For example, the opening and closing mechanism 70 may be an outer-slide opening and closing mechanism so as to open the roof opening portion 11 by moving the movable panel 30 above the roof 12.

According to the aforementioned embodiment, a sunroof apparatus 20 includes a movable panel 30 including a panel body 40 configured to open and close a roof opening portion 11 provided at a vehicle 10, a side frame (reinforcing member) 51 provided at each of opposed end portions of the panel body 40 in a width direction X of the vehicle 10 and extending in a front-rear direction Y of the vehicle 10, and a resin frame (joining layer) 60 joining the panel body 40 and the side frame 51, and an opening and closing mechanism 70 including a functional bracket (connection member) 75 connected to the side frame 51 and a drive portion (a drive portion 73, a driven portion 74, an actuator 76) configured to open and close the movable panel 30 by driving the functional bracket 75. The side frame 51 including a first flange 511, a second flange 512 provided at an inside of the first flange 511 in the width direction X to define a housing groove 51a relative to the first flange 511, the housing groove 51a extending in the front-rear direction Y, a first extending portion 515 protruding to a vehicle interior 13 from an inner end of the first flange 511 in the width direction X, and a second extending portion 516 protruding to the vehicle interior 13 from an outer end of the second flange 512 in the width direction X. The functional bracket 75 being connected to at least one of the first extending portion 515 and the second extending portion 516 in a state of being housed in a housing void 51b formed between the first extending portion 515 and the second extending portion 516. The movable panel 30 including a film (shielding member) 31 covering the housing groove 51a and including a thickness smaller than a thickness of the first flange 511 and the second flange 512.

According to the sunroof apparatus 20 including the aforementioned construction, although the resin frame 60 and the film 31 are disposed between the panel body 40 and the functional bracket 75, members corresponding to the first flange 511 and the second flange 512 are inhibited from being disposed between the panel body 40 and the functional bracket 75. At this time, the thickness of the film 31 is smaller than the thickness of the first flange 511 and the second flange 512. Thus, the functional bracket 75 may be arranged to be closer to the panel body 40. Accordingly, a reduction of thickness of the sunroof apparatus 20 in a height direction of the vehicle 10 is achievable. In addition, because the housing groove 51a formed between the first flange 511 and the second flange 512 is covered by the film 31, the resin frame 60 is restrained from being arranged towards the housing void 51b where the functional bracket 75 is arranged.

The film 31 is a film attached to the first flange 511 and the second flange 512.

Accordingly, the film 31 which covers a clearance (i.e., the housing groove 51a) between the first flange 511 and the second flange 512 may be easily constructed.

The side frame 51 includes a third flange 513 connecting between respective front ends of the first flange 511 and the second flange 512 in the front-rear direction Y and a fourth flange 514 connecting between respective rear ends of the first flange 511 and the second flange 512 in the front-rear direction Y. The housing groove 51a is formed between the third flange 513 and the fourth flange 514 and between the first flange 511 and the second flange 512. The film 31 is attached to the first flange 511, the second flange 512, the third flange 513, and the fourth flange 514.

Accordingly, the film 31 is attached to the third flange 513 and the fourth flange 514 in addition to the first flange 511 and the second flange 512. Thus, a space (portion) to which the film 31 is attached may be easily secured.

The side frame 51 is made of a material including a higher elastic modulus than the panel body 40. The movable panel 30 includes a sheet (an elastic member) 32 including a lower elastic modulus than the panel body 40 and the resin frame 60 between the panel body 40 and the side frame 51.

In a case of forming a resin frame of a movable panel by injection-molding in a sunroof apparatus, for example, the movable panel may be heated and cooled during a manufacturing process of the movable panel. In such case, because of a difference in coefficient of thermal expansion between a panel body and a side frame, strain may remain at the panel body after the movable panel is manufactured. Nevertheless, according to the present sunroof apparatus 20 with the aforementioned construction, the sheet 32 includes a lower elastic modulus between the panel body 40 and the side frame 51. As a result, the sheet 32 is actively deformed as compared to the panel body 40, so that strain is unlikely to remain at the panel body 40.

A method of manufacturing a sunroof apparatus 20, the sunroof apparatus 20 including a movable panel 30 including a panel body 40 configured to open and close a roof opening portion 11 provided at a vehicle 10, a side frame (reinforcing member) 51 provided at each of opposed end portions of the panel body 40 in a width direction X of the vehicle 10 and extending in a front-rear direction Y of the vehicle 10, and a resin frame (joining layer) 60 joining the panel body 40 and the side frame 51, and an opening and closing mechanism 70 including a functional bracket (connection member) 75 connected to the side frame 51 and a drive portion (a drive portion 73, a driven portion 74, an actuator 76) configured to open and close the movable panel 30 by driving the functional bracket 75, the side frame 51 including a first flange 511, a second flange 512 provided at an inside of the first flange 511 in the width direction X to define a housing groove 51a relative to the first flange 511, the housing groove 51a extending in the front-rear direction Y, a first extending portion 515 protruding to a vehicle interior 13 from an inner end of the first flange 511 in the width direction X, and a second extending portion 516 protruding to the vehicle interior 13 from an outer end of the second flange 512 in the width direction X, the functional bracket 75 being connected to at least one of the first extending portion 515 and the second extending portion 516 in a state of being housed in a housing void 51b formed between the first extending portion 515 and the second extending portion 516, the movable panel 30 including a film (shielding member) 31 covering the housing groove 51a and including a thickness smaller than a thickness of the first flange 511 and the second flange 512, the method includes a first process for covering the housing groove 51a by the film, a second process for arranging the panel body 40 and the side frame 51 at a molding die 101, 102, a third process for injecting a liquid material for forming the resin frame 60 to the molding die where the panel body 40 and the side frame 51 are arranged, and a fourth process for forming the resin frame 60 by hardening the liquid material.

In the aforementioned method of manufacturing the sunroof apparatus 20, in the first process, the housing groove 51a is covered by the film 31. Thus, in the third process, the liquid material is restrained from flowing to the housing void 51b. That is, in the method of manufacturing the sunroof apparatus 20, the housing void 51b for housing the functional bracket 75 is easily securable.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A sunroof apparatus comprising:
a movable panel including a panel body configured to open and close a roof opening portion provided at a vehicle, a reinforcing member provided at each of opposed end portions of the panel body in a width direction of the vehicle and extending in a front-rear direction of the vehicle, and a joining layer joining the panel body and the reinforcing member; and
an opening and closing mechanism including a connection member connected to the reinforcing member and a drive portion configured to open and close the movable panel by driving the connection member,
the reinforcing member including a first flange, a second flange provided at an inside of the first flange in the width direction to define a housing groove relative to the first flange, the housing groove extending in the front-rear direction, a first extending portion protruding to a vehicle interior from an inner end of the first flange in the width direction, and a second extending portion protruding to the vehicle interior from an outer end of the second flange in the width direction,
the connection member being connected to at least one of the first extending portion and the second extending portion in a state of being housed in a housing void formed between the first extending portion and the second extending portion,
the movable panel including a shielding member covering the housing groove and including a thickness smaller than a thickness of the first flange and the second flange.

2. The sunroof apparatus according to claim 1, wherein the shielding member is a film attached to the first flange and the second flange.

3. The sunroof apparatus according to claim 2, wherein the reinforcing member includes a third flange connecting between respective front ends of the first flange and the second flange in the front-rear direction and a fourth flange connecting between respective rear ends of the first flange and the second flange in the front-rear direction,
the housing groove is formed between the third flange and the fourth flange and between the first flange and the second flange,
the film is attached to the first flange, the second flange, the third flange, and the fourth flange.

4. The sunroof apparatus according to claim 1, wherein the reinforcing member is made of a material including a higher elastic modulus than the panel body,
the movable panel includes an elastic member including a lower elastic modulus than the panel body and the joining layer between the panel body and the reinforcing member.

5. The sunroof apparatus according to claim 2, wherein the reinforcing member is made of a material including a higher elastic modulus than the panel body,
the movable panel includes an elastic member including a lower elastic modulus than the panel body and the joining layer between the panel body and the reinforcing member.

6. The sunroof apparatus according to claim 3, wherein the reinforcing member is made of a material including a higher elastic modulus than the panel body,
the movable panel includes an elastic member including a lower elastic modulus than the panel body and the joining layer between the panel body and the reinforcing member.

7. A method of manufacturing a sunroof apparatus, the sunroof apparatus including a movable panel including a panel body configured to open and close a roof opening portion provided at a vehicle, a reinforcing member provided at each of opposed end portions of the panel body in a width direction of the vehicle and extending in a front-rear direction of the vehicle, and a joining layer joining the panel body and the reinforcing member, and an opening and closing mechanism including a connection member connected to the reinforcing member and a drive portion configured to open and close the movable panel by driving the connection member, the reinforcing member including a first flange, a second flange provided at an inside of the first flange in the width direction to define a housing groove relative to the first flange, the housing groove extending in the front-rear direction, a first extending portion protruding to a vehicle interior from an inner end of the first flange in the width direction, and a second extending portion protruding to the vehicle interior from an outer end of the second flange in the width direction, the connection member being connected to at least one of the first extending portion and the second extending portion in a state of being housed in a housing void formed between the first extending portion and the second extending portion, the movable panel including a shielding member covering the housing groove and including a thickness smaller than a thickness of the first flange and the second flange, the method comprising:
a first process for covering the housing groove by the shielding member;
a second process for arranging the panel body and the reinforcing member at a molding die;
a third process for injecting a liquid material for forming the joining layer to the molding die where the panel body and the reinforcing member are arranged; and
a fourth process for forming the joining layer by hardening the liquid material.

8. The method according to claim 7, wherein the shielding member is a film attached to the first flange and the second flange.

9. The method according to claim 8, wherein the reinforcing member includes a third flange connecting between respective front ends of the first flange and the second flange in the front-rear direction and a fourth flange connecting between respective rear ends of the first flange and the second flange in the front-rear direction,
the housing groove is formed between the third flange and the fourth flange and between the first flange and the second flange,
the film is attached to the first flange, the second flange, the third flange, and the fourth flange.

10. The method according to claim 7, wherein the reinforcing member is made of a material including a higher elastic modulus than the panel body,
the movable panel includes an elastic member including a lower elastic modulus than the panel body and the joining layer between the panel body and the reinforcing member.
